(19) United States
(12) Patent Application Publication
(10) Pub. No.: US 2019/0310470 A1
(43) Pub. Date: Oct. 10, 2019

(54) SYSTEM TO MAINTAIN A CLEAR LENS ON A CAMERA

(71) Applicant: Visteon Global Technologies, Inc., Van Buren Township, MI (US)

(72) Inventors: Paul Fredrick Luther Weindorf, Novi, MI (US); Upton Beall Bowden, Canton, MI (US); Douglas Allen Pfau, Canton, MI (US)

(21) Appl. No.: 15/949,464

(22) Filed: Apr. 10, 2018

(51) Int. Cl. G02B 27/00; B60R 11/04; B60S 1/56

(52) U.S. Cl. CPC G02B 27/0006; B60R 2011/004; B60S 1/56; B60R 11/04

(57) ABSTRACT

A system for maintaining a clear lens on a camera may include a camera housing including a camera door, a microprocessor disposed in the camera housing and including memory and instructions stored in the memory to operate the camera door in a plurality of modes to maintain the clear the lens of the camera. The system may further include an air treatment device configured to be operated by the microprocessor in the plurality of modes, a blower fan to generate pressurized air, a heater coil configured to selectively heat the pressurized air, and a plurality of shutters configured to direct the pressurized air that may be operated by at least one solenoid.

### BACKGROUND

A camera may capture images, and be employed in a variety of contexts, for example, used by an advanced driver assistance system (ADAS) to assist in operating the vehicle or to fully operate the vehicle. The camera may be used by or in connection with ADAS to determine the presence of objects relative to the position of the vehicle. For example, the camera may be used by ADAS to determine the presence of buildings and trees along a roadway. The camera may also be used by ADAS to determine the speed of the vehicle, the position of the vehicle on the roadway (i.e., lane-keeping), and to determine the position of other vehicles, pedestrians, or other objects that may be moving closer and/or farther away from the vehicle.

However, dirt and debris may appear on the camera, and affect the camera's operability and performance. Various techniques have been proposed to address this dirt, however, those techniques are not robust enough for certain situations, such as those specifically required for the automotive context.

### SUMMARY

The present disclosure aims to overcome these disadvantages by providing a system to maintain a clear lens on an automotive camera that will, in particular, prevent road debris and adverse weather from accumulating on the camera and maintain the performance of automotive vision systems.

For this purpose, a system to maintain a clear lens on an automotive camera is provided. The system for maintaining a clear lens on a camera may include a camera lens cleaning system including a camera housing with a camera door disposed in front of a lens of the camera and an air treatment device for directing pressurized air at the camera and a microprocessor including a processor and memory containing instructions to selectively operate the camera door and the air treatment device.

The system for maintaining a clear lens on a camera may include instructions for a camera clean camera off mode including closing the camera door causing a brush disposed on the camera door to clean the lens, deactivating the camera, deactivating the air treatment device, selectively opening and/or closing a plurality of shutters of the air treatment device, and deactivating a temperature sensor and a moisture sensor.

The system for maintaining a clear lens on a camera may include instructions for a camera clean camera on mode including opening the camera door causing a brush disposed on the camera door to clean the lens, activating the air treatment device, selectively opening and/or closing a plurality of shutters of the air treatment device, and activating a temperature sensor and a moisture sensor.

The system for maintaining a clear lens on a camera may include instructions for activating a heater coil of the air treatment device if the microprocessor determines that a temperature measured by the temperature sensor and and/or a dew point measured by the moisture sensor are within predetermined temperature and dew point ranges.

The system for maintaining a clear lens on a camera may include instructions for a camera clean filter clean mode including closing the camera door causing a brush disposed on the camera door to clean the lens, deactivating the camera, selectively opening and/or closing a plurality of shutters of the air treatment device, activating the air treatment device, activating a temperature sensor and a moisture sensor to clean one or more filters of the air treatment device.

The system for maintaining a clear lens on a camera may include instructions for activating a heater coil of the air treatment device if the microprocessor determines that a temperature measured by the temperature sensor and and/or a dew point measured by the moisture sensor are within predetermined temperature and dew point ranges.

The system for maintaining a clear lens on a camera may include a camera housing including a camera door, a microprocessor disposed in the camera housing and including memory and instructions stored in the memory to operate the camera door in a plurality of modes to maintain the clear the lens of the camera.

The system for maintaining a clear lens on a camera may include a camera housing that includes an air treatment device configured to be operated by the microprocessor in the plurality of modes.

The system for maintaining a clear lens on a camera may include a blower fan to generate pressurized air.

The system for maintaining a clear lens on a camera may include an air treatment device that includes a heater coil configured to selectively heat the pressurized air.

The system for maintaining a clear lens on a camera may include an air treatment device that include a plurality of shutters configured to direct the pressurized air within the air treatment device.

The system for maintaining a clear lens on a camera may include a plurality of shutters that may be operated by at least one solenoid.

The system for maintaining a clear lens on a camera may include a microprocessor that may be configured to operate a door switch connected to the camera door in the plurality of modes.

The system for maintaining a clear lens on a camera may include a plurality of shutters that may be configured to be operated by a solenoid controlled by the microprocessor.

The system for maintaining a clear lens on a camera may include a microprocessor that may be electrically connected to a temperature sensor and a moisture sensor.

The system for maintaining a clear lens on a camera may include a microprocessor that may be configured to measure temperature and/or moisture and selectively operate the air treatment device in the plurality of modes.

The system for maintaining a clear lens on a camera may include a plurality of modes that may include a camera clean on mode, a camera clean camera off mode, and a camera clean filter clean mode.

The system for maintaining a clear lens on a camera may include a microprocessor with a memory and instructions stored on the memory to operate the system that may include a plurality of modes to maintain the clear lens on a camera.

The system for maintaining a clear lens on a camera may include a microprocessor with a memory and instructions that may include a camera clean camera on mode wherein the microprocessor activates a camera door switch to open a camera door in front of the lens of the camera, activates a blower fan to pressurize air, measures ambient temperature and moisture, determines whether the measured ambient temperature and/or moisture are within predetermined ranges, activates a heater coil based at least in part on that determination, and activates at least one solenoid to selectively operate a plurality of shutters in fluid communication with the pressurized air causing the pressurized air to maintain the clear lens on the camera, a camera clean camera off mode wherein the microprocessor activates the camera door switch to close the camera door in front of the lens of the camera, deactivates the blower fan, and deactivates the heater coil, and a camera clean filter clean mode wherein the microprocessor activates the camera door switch to close the camera door in front of the lens of the camera, activates the blower fan to pressurize air, measures ambient temperature and moisture, determines whether the measured ambient temperature and/or moisture are within predetermined ranges, activates a heater coil based at least in part on that determination, and activates at least one solenoid to selectively operate a plurality of shutters in fluid communication with the pressurized air causing the pressurized air to clean a plurality of filters.

### BRIEF DESCRIPTION OF DRAWINGS

Other advantages of the present disclosure will be readily appreciated, as the same becomes better understood by reference to the following detailed description when considered in connection with the accompanying drawings wherein:

FIG. 1 is a sectional view of a system to maintain a clear lens on an automotive camera, illustrating the system in the camera on clean mode, according to an aspect of the disclosure;

FIG. 2 is a sectional view of the system of FIG. 1, illustrating the system in the camera off mode, according to an aspect of the disclosure;

FIG. 3 is a sectional view of the system of FIG. 2, illustrating the system in the camera on filter clean mode, according to an aspect of the disclosure; and

FIG. 4 is a flowchart of an embodiment of the logic of a microprocessor of the system, according to an aspect of the disclosure.

### DETAILED DESCRIPTION

The camera may be positioned at various locations about the exterior of the vehicle, such as the front, rear, or sides of the vehicle. The camera may be positioned in a vehicle bumper, mirrors, tailgate/hatch, or other body panels and/or trim elements (e.g., a license plate finisher). The camera may be configured as part of or integrated with another component, such as an emblem, grille, headlight, taillight, or fog light. The cameras may be configured with or as an accessory item to be added to the vehicle, such as a rear air spoiler, roof rack, or vehicle side step.

In addition, in order to keep the camera clean and free or dirt and debris, the camera may be mounted in a housing with a camera lens clearing system and a camera door with a membrane. The camera lens clearing system may be configured to operate to keep the lens of the camera clear by blowing air from behind the camera, over the lens, to deflect dirt and debris from fouling the camera while the vehicle is operating. As the camera lens clearing system intakes air from the surroundings, the system includes filters to remove dirt and debris from the intake air. The camera lens clearing system is also configured with a filter cleaning mode to use reverse air flow to clean the filters.

The camera may be positioned at various locations about the exterior of the vehicle, such as the front, rear, or sides of the vehicle. The camera may be positioned in a vehicle bumper, mirrors, tailgate/hatch, or other body panels and/or trim elements (e.g., a license plate finisher). The camera may be configured as part of or integrated with another component, such as an emblem, grille, headlight, taillight, or fog light. The cameras may be configured with or as an accessory item to be added to the vehicle, such as a rear air spoiler, roof rack, or vehicle side step.

In addition, in order to keep the camera clean and free or dirt and debris, the camera may be mounted in a housing with a camera lens clearing system and a camera door with a membrane. The camera lens clearing system may be configured to operate to keep the lens of the camera clear by blowing air from behind the camera, over the lens, to deflect dirt and debris from fouling the camera while the vehicle is operating. As the camera lens clearing system intakes air from the surroundings, the system includes filters to remove dirt and debris from the intake air. The camera lens clearing system is also configured with a filter cleaning mode to use reverse air flow to clean the filters.

Referring to the Figures, wherein like numerals indicate corresponding parts throughout the several views, a system 10 to maintain a clear lens on an automotive camera is generally shown. Maintaining a clear lens on an automotive camera is desirable as the automotive camera may be used for driver assistance or an ADAS. For example, an automotive camera located in the rear of a vehicle, is susceptible to accumulation of road debris, particularly in poor weather conditions. In a snowy environment for example, the rear of a vehicle may become coated with snow and/or ice, covering an automotive camera without a system to maintain a clear lens and rendering it unusable. In a dusty environment, the rear of the vehicle may become coated with dust and dirt, covering an automotive camera without a system to maintain a clear lens and also rendering it unusable. Similarly, an automotive camera located in the front of a vehicle, such as in a front bumper/fascia, may also be exposed to accumulating snow, ice, dirt, rain, as well as insects and other miscellaneous road debris. Even an automotive camera located elsewhere on the vehicle, such as the side or roof may also be susceptible to road debris.

What is needed then is a system to maintain a clear lens on an automotive camera that includes an air treatment device with a blower fan to accelerate air and direct it over the automotive camera forming an air curtain that deflects road debris away from the automotive camera. The system may include a heater coil to heat air accelerated by the blower fan to melt snow and ice and keep it from forming on the automotive camera by warming the camera and the surrounding area. The system may include a camera door that may be configured to close when the camera is not needed (vehicle not operating) to protect the camera or when the system is a filter cleaning mode. The camera door may include a membrane that further protects the camera but does not negatively impact the images produced by the camera (inside the focal point of the camera). The camera door may also include a camera brush that may sweep the camera during opening and closing of the camera door by the system. The system may include filters to trap road debris drawn into the system by the blower fan, and a filter cleaning mode to expel the road debris out of the system and away from the camera. The system may include a temperature sensor and/or a moisture sensor to determine the present temperature and dew point and activate the heater coil accordingly.

It should be understood that the system described herein may be included with cameras outside of automotive and/or transportation applications, such as a stand-alone camera. In such embodiments, the system may include a power supply (i.e., a battery), and may include additional and/or different instructions to operate independently (i.e., not part of a larger system).

In embodiments, system 10 may include an air treatment device 66 with an outer housing 12 including an outer air channel 22 and an inner air channel 24, wherein the outer air channel 22 includes a camera door 26 with a camera door aperture 60, an outer housing camera aperture 28, a heater coil 30, a blower fan 32, a pair of air intakes 34A-34B, a foam filter 36 and an ionic filter 38. Inner air channel 24 may be in fluid communication with outer air channel 22 via a plurality of shutters 44A-44C that may be configured to selectively control air flow between outer air channel 22, inner air channel 24 and outer housing camera aperture 28. An inner housing 14 may be disposed within outer housing 12 and in fluid communication with at least a portion of outer air channel 22 and inner air channel 24 and may include an inner housing camera aperture 40. A printed wiring board (PWB) 16 may be disposed within inner housing 14. PWB 16 may further include at least one solenoid 42 that may be configured to operate plurality of shutters 44A-44C, a camera door switch 46, a temperature sensor 48, and a moisture sensor 50. A camera 18 may be disposed on PWB 16 and may be configured to engage outer housing camera aperture 28 and inner housing camera aperture 40. A microcontroller 20 may be disposed on PWB 16. Microcontroller 20 may include a processor and memory containing instructions to operate system 10 at least in a camera cleaning mode, in a filter cleaning mode, and a camera off mode.

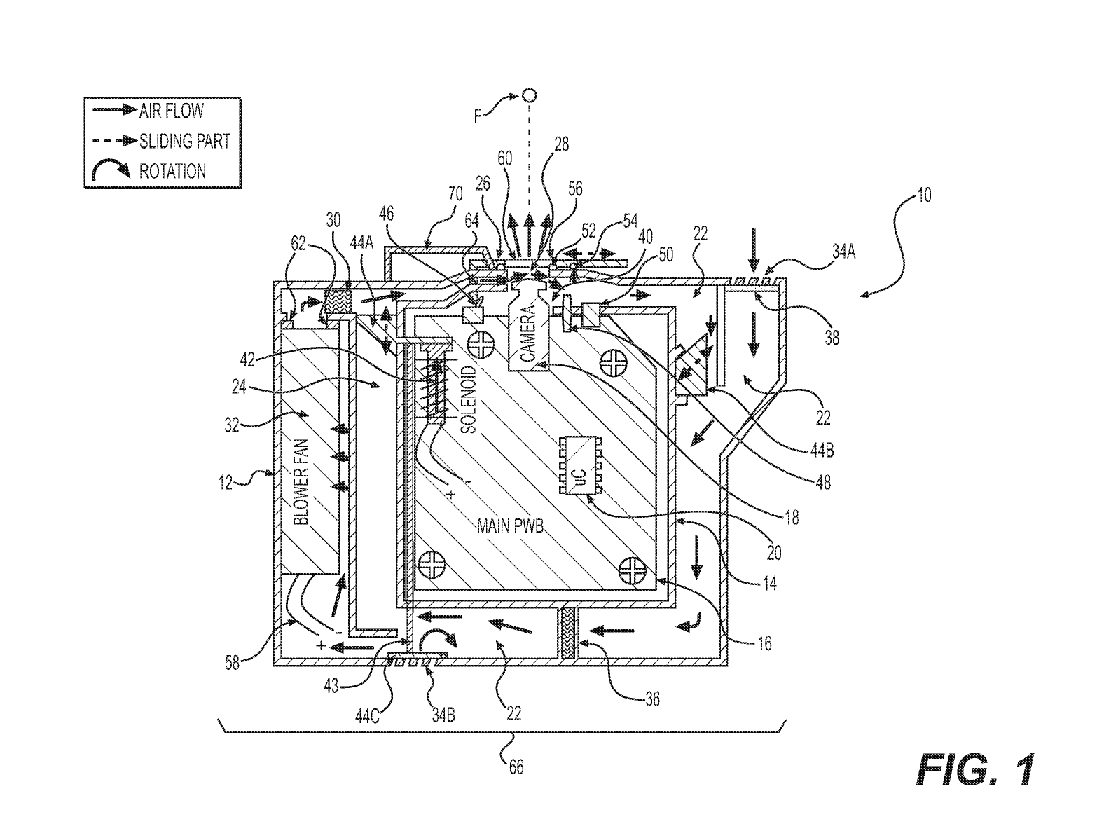

FIG. 1 illustrates system 10 in the camera clean on mode. In this mode, camera 18 may be capturing images including those at focal point F. During camera clean on mode, air may be drawn into intake 34A (and air may be additionally forced into intake 34A if intake 34A is oriented in the direction of vehicle travel). The drawn air passes through intake 34A, which may be configured with a grate or grille, to prevent larger particles and/or objects from entering system 10. Ionic filter 38 may be disposed adjacent to intake 34A and may filter the drawn air passing through intake 34A. Once the drawn air passes through intake 34A and filtered by ionic filter 38, the drawn air enters outer air channel 22 of outer housing 12, passing by shutter 44B. In this mode, shutter 44B is in an open position, allowing some of the drawn air previously drawn in via intake 34A filtered and/or heated and passed over camera 18, to recycle to the drawn air flow. The drawn air continues past open shutter 44B within outer air channel 22, which may be formed between outer housing 12 and inner housing 14. The drawn air passes through foam filter 36 disposed in outer air channel 22 downwind from intake 34A and ionic filter 38. Once the drawn air passes through and may be filtered by foam filter 36, the drawn air may pass by closed shutter 44C, which may seal intake 34B in this mode. The drawn air may then encounter inner air channel 24, which may be disposed adjacent to outer air channel 22 and selectively interacts with shutter 44C, in this embodiment. Inner air channel 24 may be configured as a bypass of a portion of outer air channel 22 via shutter 44C, as will described in further detail below.

In the camera clean on mode, the drawn air next encounters blower fan 32, which may be configured to create positive air flow with the drawn air in outer air channel 22. Blower fan 32 may be configured in outer air channel 22 such that a blower fan gasket 62 (i.e., seal), may engage outer air channel 22 and/or inner air channel 24 and may prevent any of the drawn air from bypassing blower fan 32. Blower fan 32 may be configured to receive electrical power from the vehicle (or PWB 16, microcontroller 20) via blower fan wires 58. In this mode, blower fan 32 may accelerate (i.e., pressurize), the drawn air within outer air channel 22 and may force it through heater coil 30.

In the camera clean on mode, heater coil 30 may be configured to warm (i.e., heat), the drawn air exiting blower fan 32 in outer air channel 22. Heater coil 30 may be controlled via microcontroller 20, which may be programmed to receive and/or analyze signals from temperature sensor (e.g., a thermistor) 48 and/or moisture sensor 50 that may be disposed on PWB 16 and in fluid communication with outer air channel 22. For example, at temperatures near or below freezing, microcontroller 20 may be programmed to activate heater coil 30, in anticipation of camera 18 encountering rain, snow, or ice. In another example, microcontroller 20 may also be programmed to activate heater coil 30 when detecting a predetermined range of dew points, in order to clear fog (i.e., water droplets), from fouling camera 18. Additionally, if microcontroller 20 detects predetermined elevated temperature (e.g., temperatures over 5 degrees C.), microcontroller 20 may not activate heater coil 30. The (optionally) heated drawn air exiting heater coil 30 may bypass closed shutter 44A, which may prevent the drawn air from traveling through inner air channel 24. The drawn air may then pressurized further by a narrowing of outer air channel 22 between outer housing 12 and inner housing 14 near outer housing camera aperture 28 and/or inner housing camera aperture 40. The solenoid will physically move 44A, 44B and 44C, and as such a linkage element 43 between 44A, 44B, 44C such that they can move in concert with the solenoid.

In the camera clean on mode, as the pressurized air approaches camera 18 in outer air channel 22, the drawn air may pass through a passage 64 in camera door 26, which may be configured to engage outer housing 12 and inner housing 14 and may be sealed against outer housing 12 by camera door gasket 52. In this mode, a camera door switch 46, disposed on PWB 16 and activated by microcontroller 20, may position camera door 26 such that passage 64 may be aligned with outer air channel 22, allowing the pressurized air to flow through passage 64 and toward camera 18. Next, the pressurized air, accelerated by blower fan 32 and optionally heated by heater coil 30, may exit outer air channel 22 adjacent to camera 18. The pressurized air, having been filtered by foam filter 36 and ionic filter 38, accelerated by blower fan 32, and (optionally) heated by heater coil 30, may form an air curtain of high pressure air flowing over camera 18. The air curtain may deflect foreign material, such as road debris and water (in liquid and frozen form) from attaching to the lens of camera 18.

In the camera clean on mode, some of the drawn air exits the system 10 via camera door aperture 60 in camera door 26. Camera door 26 may include a mesh screen 56 (e.g., a membrane), that may be configured over camera door aperture 60 in front of camera 18, in this mode. Mesh screen 56 may be configured to protect camera 18 and/or avoid the need to physically wipe the lens of camera 18. Mesh screen 56 may be configured inside the focal point F of camera 18, rendering mesh screen 56 largely invisible to camera 18. In this mode, the pressurized air curtain and mesh screen 56 may be configured to prevent foreign material (e.g., road debris, water, snow and ice), from fouling camera 18. The heat generated by coil 30 will be sufficient to melt minor amounts of built up ice and snow. A protected mounting are is preferred to minimize ice buildup, however, in the case of extreme ice buildup, software algorithms are to be implemented such that the door switch 46 and the temperature sensor 48 are monitored and if the door open switch does not trigger and a low temperature is received, a warning is sent to the vehicle operator that ice buildup has occurred and the camera door needs to be deiced to allow for proper camera operation.

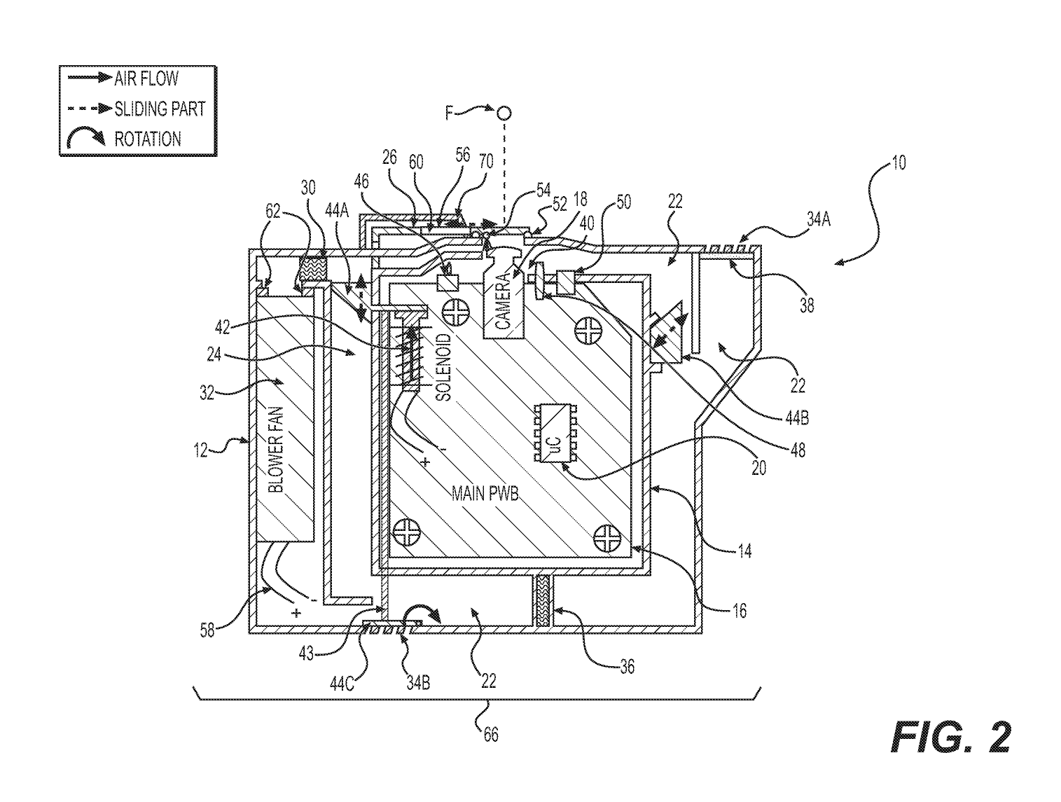

FIG. 2 illustrates system 10 in another mode, the camera clean off mode. In this mode, a vehicle may be in a state of deactivation (i.e., shutdown) or may be completely deactivated (i.e., not operating). If the vehicle is in a state of deactivation, microcontroller 20, upon receiving a signal from the vehicle and/or detecting the shutdown, may be configured to deactivate blower fan 32. Microcontroller 20 may also be configured to activate camera door switch 46 to close camera door 26, causing camera door aperture 60 to move out of alignment with camera 18. Camera door 26 may also include camera brush 54, which, during the closing of camera door 26 by camera door switch 46, may clean the lens of camera 18. Camera door 26, once closed, may be configured to cover camera 18. Camera door 26 may also be configured with passage 64, which may be in fluid communication at least with outer air channel 22 in the camera clean on mode, but upon shutdown, may be configured to seal outer air channel 22 near the outlet of outer air channel 22, downwind of the blower fan 32, heater coil 30, and shutter 44A. Microcontroller 20 may be configured to maintain shutters 44A-44C in the respective positions as the camera clean on mode (i.e., shutters 44A-44B open, shutter 44C closed). During a period of vehicle inactivity, camera clean off mode may maintain camera door 26 closed, blower fan 32 off, heater coil 30 off, shutters 44A-44B open, and shutter 44C closed. In addition, there is a door seal 70 (or cap) over the door mechanical area to protect the camera from foreign materials and to keep the pressure high enough to allow the door to open properly. If the vehicle is turned off the battery line would continue to supply power until the cycle is completed. In the event of a full power failure, all elements are to be spring loaded such that they return to closed mode.

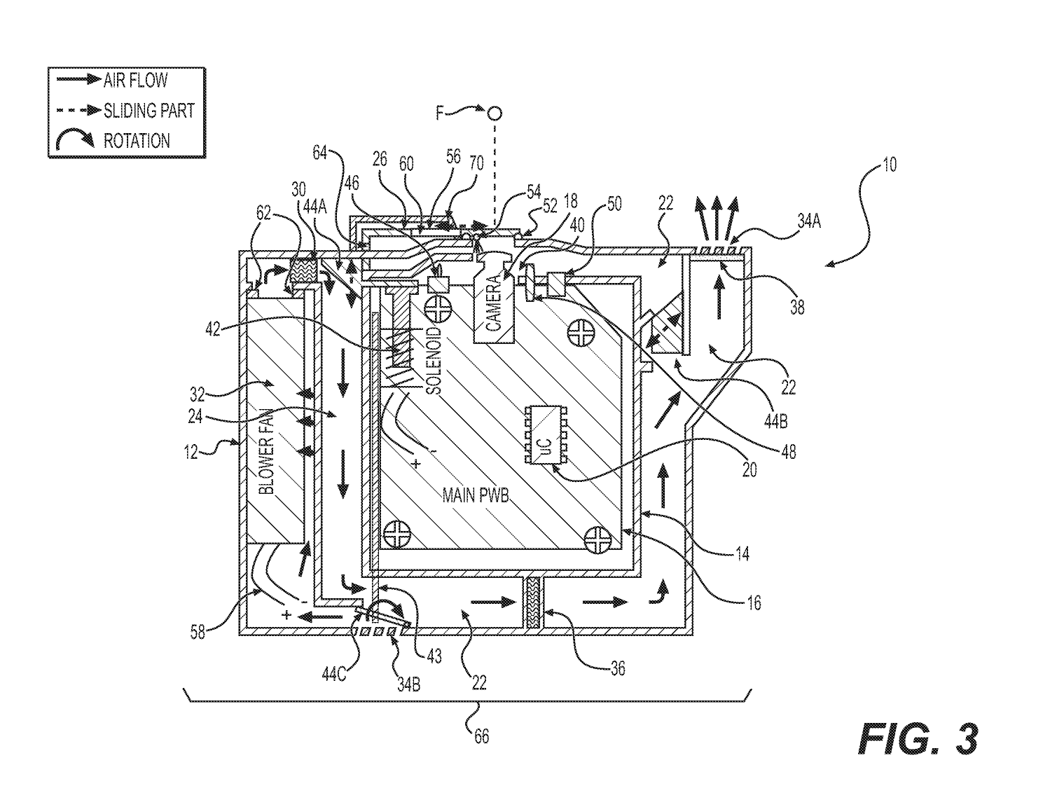

FIG. 3 illustrates system 10 in the camera clean filter clean mode. In this mode, system 10 may be configured to clean one or both of foam filter 36 and/or ionic filter 38. In this embodiment, one or both of foam filter 36 and/or ionic filter 38 may be cleaned when microcontroller 20 may receive a signal from the vehicle, may detect a loss in performance of camera 18, or may clean according to a predetermined schedule (e.g., miles traveled, weather information received from the vehicle, upon vehicle startup/shutdown). In this mode, microcontroller 20 may activate solenoid 42 to close shutters 44A-44B, and open shutter 44C. As a result, air may be drawn in through intake 34B into outer air channel 22 upon activation of blower fan 32. The drawn air, which may in this mode be from an internal portion of the vehicle (e.g., within a body panel or fascia), enters outer air channel 22 but may be prevented from immediately entering adjacent inner air channel 24 due the position of blocking configuration of shutter 44C. Blower fan 32 may be configured in outer air channel 22 such that blower fan gasket 62 (i.e., may engage outer air channel 22 and may prevent any of the drawn air from bypassing blower fan 32. In this mode, blower fan 32 pressurizes the drawn air within outer air channel 22 and forces it through heater coil 30. For a routine clearing, the system may be equipped with a counter to track mileage and at a given check point, the next time the system is shut down, the battery line will draw power to run the clearing cycle while the vehicle is shut down. If extreme conditions occur and the camera is in need of clearing prior to routine maintenance, during a camera on condition, a warning would need to flash on the display indicating that the camera will be non-operational for two minutes while the camera is in self-cleaning (clearing) mode.

In the camera clean filter clean mode, heater coil 30 may be configured to warm the drawn air exiting blower fan 32 in outer air channel 22. Heater coil 30 may be controlled via microcontroller 20, which may be programmed to receive and/or analyze signals from temperature sensor (e.g., a thermistor) 48 and/or moisture sensor 50 that may be disposed on PWB 16 and in fluid communication with outer air channel 22. For example, at temperatures near or below freezing, microcontroller 20 may be programmed to activate heater coil 30. In another example, microcontroller 20 may also be programmed to activate heater coil 30 when detecting a predetermined range of dew points, in order to clear fog in the pressurized air. Additionally, if microcontroller 20 detects an elevated temperature (e.g., temperatures over 5 degrees C.), microcontroller 20 may not activate heater coil 30.

In the camera clean filter clean mode, the pressurized air exiting heater coil 30 (whether heated or not) may be directed by closed shutter 44A into inner air channel 24. It should be noted that due to the closed position of camera door 26, passage 64 may prevent contaminated air from reaching camera 18. As described above, shutter 44A may be moved by solenoid 42 to seal the outlet of outer air channel 22 near camera 18 in this mode. The drawn air then travels through inner air channel 24 and may be directed by shutter 44C (may also be operated by solenoid 42) toward contaminated foam filter 36. By propelling the drawn air by blower fan 32 through contaminated foam filter 36 in the opposite direction as in the camera clean on mode, the pressurized air may remove foreign material trapped in (i.e., contaminating), foam filter 36. The pressurized air, carrying the foreign material expelled from foam filter 36 may travel through outer air channel 22 in the opposite direction as the filtered air in the camera clean on mode. The pressurized air, with foreign material from contaminated foam filter 36, may encounter shutter 44B, moved to a closed positon by microcontroller 20 using solenoid 42. As a result, the pressurized air with foreign material may not backtrack past shutter 44B, through outer air channel 22, toward camera 18. Next, the pressurized air contaminated with foreign material may encounter ionic filter 38 and/or air intake 34A. Microcontroller 20 may deactivate ionic filter 38 during the camera clean filter clean mode, so as to prevent ionic filter 38 from retaining any foreign material as the pressurized air with foreign material may be expelled via outer air channel 22 and/or intake 34A. In addition, any foreign material attached to ionic filter 38 may also be expelled as the pressurized air exits air intake 34A.

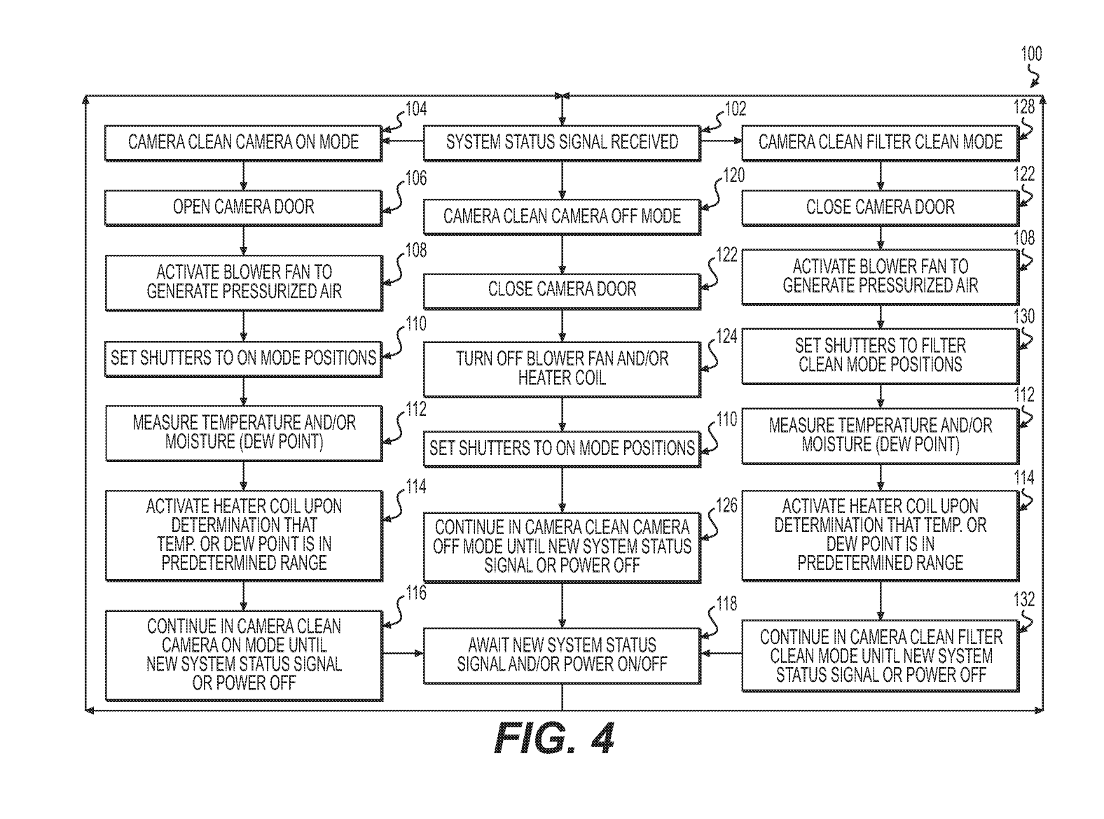

FIG. 4 illustrates an embodiment of logic and/or instructions 100 stored in memory accessible by microprocessor 20 to operate system 10. Microprocessor 20 may receive a system status signal 102, such as from a vehicle and/or ADAS system. The status signal may include an activation (i.e., turn on vehicle/system) or operation (i.e., vehicle being driven) signal, a deactivation/shutdown (i.e., turn off vehicle/system) signal, or a filter clean signal.

If an activation or operation signal is received, microprocessor 20 access instructions in memory for camera clean camera on mode 104 and executes at least those instructions. The instructions for camera clean camera on mode 104 may include open camera door 106; activate blower fan to generate pressurized air 108; set shutters to on mode positions 110; measure temperature and/or moisture 112; activate heater coil upon determination (by microprocessor 20 and/or another system (i.e., ADAS), that temperature and/or dew point is in a predetermined range 114; and continue in camera clean camera on mode until another (i.e., different), system status signal is received by microprocessor 20 116. The instructions may include awaiting a new system status signal and/or power off signal is received 118. It should be understood that the instructions described above may occur sequentially, simultaneously, or a combination thereof.

If a deactivation/shutdown signal is received, microprocessor 20 access instructions in memory for camera clean camera off mode 120 and executes at least those instructions. The instructions for camera clean camera off mode 120 may include close camera door 122; turn off blower fan and/or heater coil 124; set shutters to on mode positions 110; and continue in camera clean camera off mode until another (i.e., different), system status signal is received by microprocessor 20 126. The instructions may include awaiting a new system status signal and/or power off signal is received 118. It should be understood that the instructions described above may occur sequentially, simultaneously, or a combination thereof.

If a filter clean signal is received, microprocessor 20 access instructions in memory for camera clean filter clean mode 128 and executes at least those instructions. The instructions for camera clean filter clean mode 128 may include close camera door 122; activate blower fan to generate pressurized air 108; set shutters to filter clean mode positions 130; measure temperature and/or moisture 112; activate heater coil upon determination that temperature and/or dew point is in a predetermined range 114; continue in camera clean filter clean mode until another (i.e., different), system status signal is received by microprocessor 20 132. The instructions may include awaiting a new system status signal and/or power off signal is received 118. It should be understood that the instructions described above may occur sequentially, simultaneously, or a combination thereof.

It is obvious that the disclosure is not limited to the embodiment(s) described and shown in the accompanying drawings. Modifications are possible, especially from the point of view of the make-up of the various elements or by substitution of technical equivalents, without departing from the scope of protection of the disclosure.

1. A system for maintaining a clear lens on a camera, comprising:
a camera lens cleaning system including a camera housing with a camera door disposed in front of the lens of the camera and an air treatment device for generating and/or directing pressurized air at the camera; and
a microprocessor including a processor and memory containing instructions to selectively operate the camera door and the air treatment device.

2. The system of claim 1, wherein the instructions include a camera clean camera off mode comprising closing the camera door causing a brush disposed on the camera door to clean the lens, deactivating the camera, deactivating the air treatment device, selectively opening and/or closing a plurality of shutters of the air treatment device, and deactivating a temperature sensor and a moisture sensor.

3. The system of claim 1, wherein the instructions include a camera clean camera on mode comprising opening the camera door causing a brush disposed on the camera door to clean the lens, activating the air treatment device, selectively opening and/or closing a plurality of shutters of the air treatment device, and activating a temperature sensor and a moisture sensor.

4. The system of claim 3, wherein the instructions include activating a heater coil of the air treatment device if the microprocessor determines that a temperature measured by the temperature sensor and and/or a dew point measured by the moisture sensor are within predetermined temperature and dew point ranges.

5. The system of claim 1, wherein the instructions include a camera clean filter clean mode comprising closing the camera door causing a brush disposed on the camera door to clean the lens, deactivating the camera, selectively opening and/or closing a plurality of shutters of the air treatment device, activating the air treatment device, activating a temperature sensor and a moisture sensor to clean one or more filters of the air treatment device.

6. The system of claim 5, wherein the instructions include activating a heater coil of the air treatment device if the microprocessor determines that a temperature measured by the temperature sensor and and/or a dew point measured by the moisture sensor are within predetermined temperature and dew point ranges.

7. A system for maintaining a clear lens on a camera, comprising:
a camera housing including a camera door;
a microprocessor disposed in the camera housing and including memory and instructions stored in the memory to operate the camera door in a plurality of modes to maintain the clear the lens of the camera.

8. The system of claim 7, wherein the camera housing includes an air treatment device configured to be operated by the microprocessor in the plurality of modes.

9. The system of claim 8, wherein the air treatment device includes a blower fan to generate pressurized air.

10. The system of claim 9, wherein the air treatment device includes a heater coil configured to selectively heat the pressurized air.

11. The system of claim 9, wherein the air treatment device includes a plurality of shutters configured to direct the pressurized air within the air treatment device.

12. The system of claim 11, wherein the plurality of shutters are operated by at least one solenoid.

13. The system of claim 7, wherein the microprocessor is configured to operate a door switch connected to the camera door in the plurality of modes.

14. The system of claim 11, wherein the plurality of shutters are configured to be operated by a solenoid controlled by the microprocessor.

15. The system of claim 7, wherein the microprocessor is electrically connected to a temperature sensor and/or a moisture sensor.

16. The system of claim 10, wherein the microprocessor is configured to measure temperature and/or moisture and selectively operate the air treatment device in the plurality of modes.

17. The system of claim 1, wherein the plurality of modes include a camera clean on mode, a camera clean camera off mode, and a camera clean filter clean mode.

18. A microprocessor for use in a system to maintain a clear lens on a camera, the microprocessor comprising:
a memory; and
instructions stored on the memory to operate the system include a plurality of modes to maintain the clear lens on a camera.

19. The microprocessor of claim 18, wherein the plurality of modes include:
a camera clean camera on mode wherein the microprocessor activates a camera door switch to open a camera door in front of the lens of the camera, activates a blower fan to pressurize air, measures ambient temperature and moisture, determines whether the measured ambient temperature and/or moisture are within predetermined ranges, activates a heater coil based at least in part on that determination, and activates at least one solenoid to selectively operate a plurality of shutters in fluid communication with the pressurized air causing the pressurized air to maintain the clear lens on the camera;
a camera clean camera off mode wherein the microprocessor activates the camera door switch to close the camera door in front of the lens of the camera, deactivates the blower fan, and deactivates the heater coil; and
a camera clean filter clean mode wherein the microprocessor activates the camera door switch to close the camera door in front of the lens of the camera, activates the blower fan to pressurize air, measures ambient temperature and moisture, determines whether the measured ambient temperature and/or moisture are within predetermined ranges, activates a heater coil based at least in part on that determination, and activates at least one solenoid to selectively operate a plurality of shutters in fluid communication with the pressurized air causing the pressurized air to clean a plurality of filters.
